(19) United States
(12) Patent Application Publication
(10) Pub. No.: US 2014/0115691 A1
(43) Pub. Date: Apr. 24, 2014

(54) UNLOCKING SYSTEM AND METHOD

(71) Applicant: HON HAI PRECISION INDUSTRY CO., LTD., New Taipei (TW)

(72) Inventor: CHIH-YUAN YANG, New Taipei (TW)

(21) Appl. No.: 13/922,844

(22) Filed: Jun. 20, 2013

(30) Foreign Application Priority Data
Oct. 18, 2012 (CN) 2012103973244

(51) Int. Cl. G06F 21/00

(52) U.S. Cl. CPC G06F 21/00
USPC 726/16

(57) ABSTRACT

An unlocking system and an unlocking method of an electronic device are provided. When the electronic device in a lock state is moved during an unlock operation, the electronic device analyzes the movement of the electronic device based on its acceleration and direction and calculates a movement vector along each axis and draws an unlocking graphic. The electronic device determines whether the unlocking graphic is the same as a preset unlocking graphic. If the unlocking graphic is the same as a preset unlocking graphic, the electronic device is changed from the lock state to an unlock state.

### BACKGROUND

1. Technical Field

Embodiments of the present disclosure relate to an unlocking technology, more particularly, to an unlocking system and a method for unlocking an electronic device.

2. Description of Related Art

Unlocking an electronic device for use may require entry of an alphanumeric pass code by the user. However, recall of such various alphanumeric pass codes may be difficult sometimes.

### BRIEF DESCRIPTION OF THE DRAWINGS

FIG. 1 is a block diagram of one embodiment of an electronic device comprising an unlocking system.

FIG. 2 is a block diagram of the unlocking system of FIG. 1.

FIG. 3 shows a first schematic diagram of two component vectors of a movement along two axis directions of the electronic device of FIG. 1.

FIG. 4 shows a second schematic diagram of two component vectors of a movement along two axis directions of the electronic device of FIG. 1.

FIG. 5 is a flowchart illustrating one embodiment of a method of unlocking an electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module” as used in the present disclosure refers to logic embodied either in hardware or firmware or in a collection of software instructions written in a programming language such as Java, C, or Assembly. One or more software instructions in the module may be embedded in firmware, such as an EPROM. It should be known that the module may comprise connected logic units, such as gates and flip-flops, and may comprise programmable units such as programmable gate arrays or processors. The module described herein may be implemented as software and/or hardware and may be stored in any type of computer-readable format or other computer storage device.

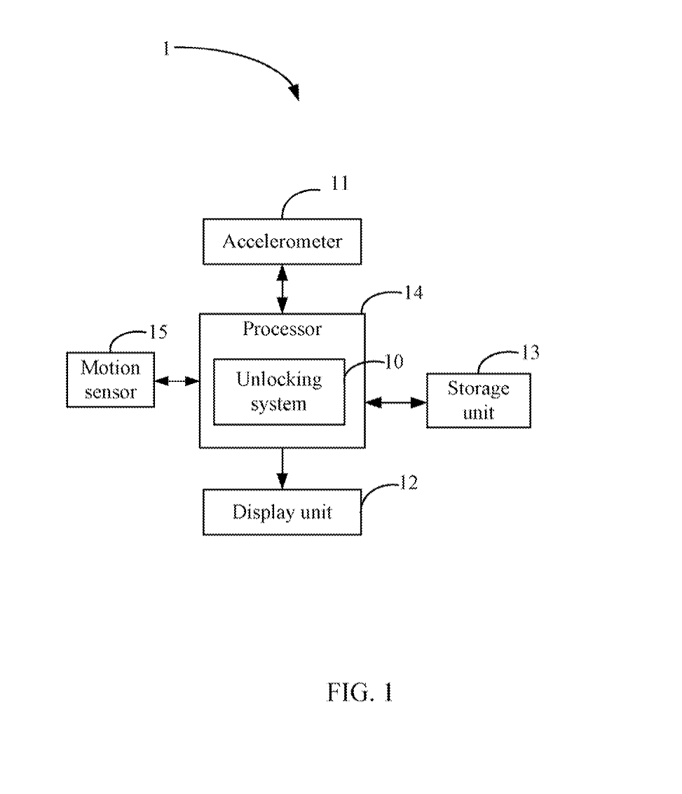

FIG. 1 is a block diagram of one embodiment of an electronic device 1 executing an unlocking system 10. The electronic device 1 further includes an accelerometer 11, a display unit 12, a storage unit 13, at least one processor 14, and a motion sensor 15. When the electronic device 1 is in a lock state, the display unit 12 is turned off and a number of hard keys on the electronic device 1 are disabled. Otherwise, when the electronic device 1 is in an unlock state, the display unit 12 is turned on, and all the hard keys on the electronic device 1 are enabled.

The electronic device 1 in the lock state can be changed to an unlock state by moving the electronic device 1 in a predetermined fashion. If a detected movement of the electronic device 1 is the same as the predetermined movement, the electronic device 1 in the lock state will be changed to the unlock state. Depending on the embodiment, the electronic device 1 may be a mobile phone, a personal digital assistant (PDA), etc.

The electronic device 1 is generally controlled and coordinated by an operating system, such as UNIX, Linux, Windows 95, 98, NT, 2000, XP, Vista, Mac OS X, an embedded operating system, or any other compatible operating system. In other embodiments, the electronic device 1 may be controlled by a proprietary operating system. Conventional operating systems control and coordinate computer processes for execution, manage memory, provide file system, networking, and I/O services, provide a user interface, such as a graphical user interface (GUI), etc.

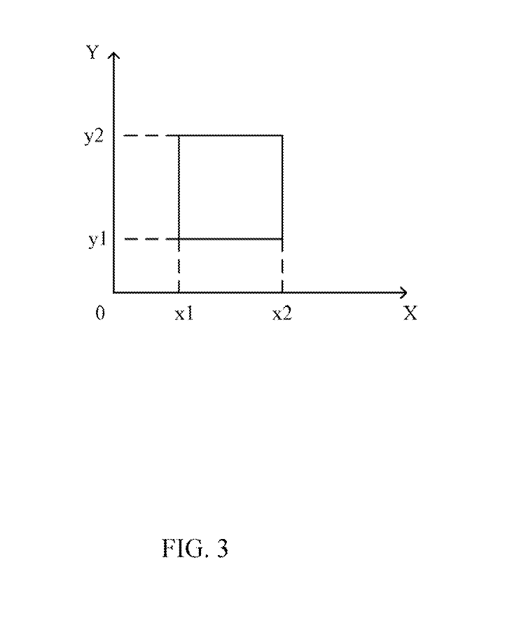

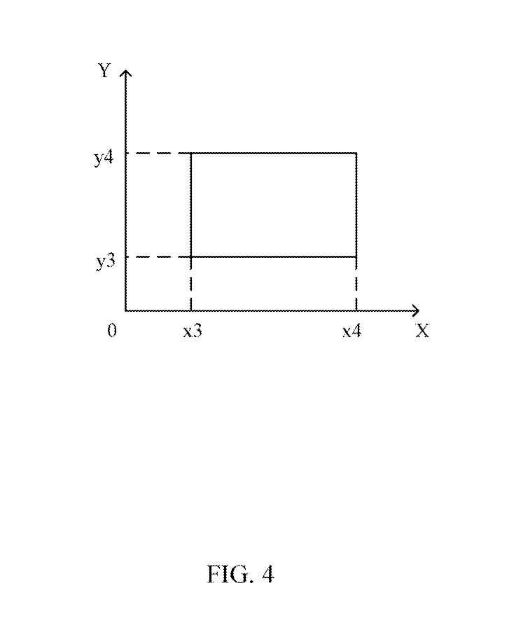

The accelerometer 11 and the motion sensor 15 detect a movement of the electronic device 1 and discern the magnitude and direction of the movement as a vector quantity to generate a movement vector on each axis direction. In the embodiment, the accelerometer 11 and the motion sensor 15 sense the movement of the electronic device 1 in response to an operation of unlocking from the user when the electronic device 1 is in the lock state. For example, the user can generate the operation via a hard key on the electronic device 1. As shown in FIGS. 3 and 4, the accelerometer 11 is a two-axis position sensor and detects the movement of the electronic device 1 with the motion sensor 15 to generate a two-dimension graphic, such as a rectangle, any character, or any symbol. In another embodiment, the accelerometer 11 is a three-axis position sensor and detects the movement of the electronic device 1 with the motion sensor 15 to generate a three-dimension graphic, such as a cube.

The display unit 12 displays information of the electronic device 1. In one embodiment, the display unit 12 displays directional information of the electronic device 1, such as a direction along a two-coordinate axis. In other embodiments, the display unit 12 also displays a notification message indicating the unlock state of the electronic device. In addition, the display unit 12 can be a display screen, a resistive touch screen, or a capacitive touch screen. Furthermore, if the electronic device 1 is in the lock state, the display unit 12 will be turned off.

The storage unit 13 is electronically connected to the unlocking system 10, the accelerometer 11, the display unit 12, the processor 14, and the motion sensor 15. The storage unit 13 stores many kinds of data such as module codes, computerized codes of the unlocking system 10, programs of the operating system, other applications of the electronic device 1, and the movement information of the electronic device 1. The preset unlocking graphic is generated by the accelerometer 11 and the motion sensor 15 or is pre-stored. The preset unlocking graphic may be a two-dimension graphic or a three-dimension graphic. The storage unit 13 may include a hard disk drive, flash memory, RAM, ROM, cache, or external storage mediums.

The processor 14 executes one or more computerized codes of the unlocking system 10 and the electronic device 1. The computerized codes of the unlocking system 10 and the electronic device 1 may be stored in the storage unit 13 and executed by the processor 14. The processor 14, as an example, may include a CPU, math coprocessor, or shift register. The motion sensor 15 senses movement directions of the electronic device 1.

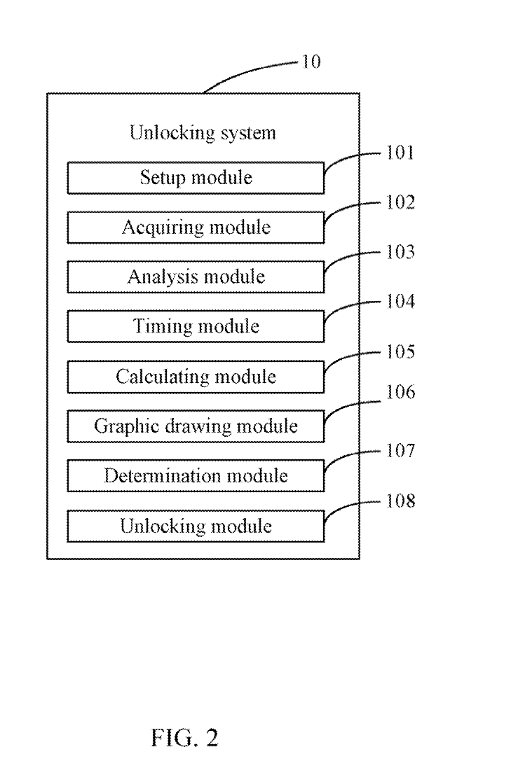

FIG. 2 is a block diagram of the unlocking system 10. The unlocking system 10 includes a setup module 101, an acquiring module 102, an analysis module 103, a timing module 104, a calculating module 105, a graphic drawing module 106, a determination module 107, and an unlocking module 108.

The setup module 101 setups the preset unlocking graphic in the storage unit 13. When the electronic device 1 responds to the operation of unlocking the electronic device 1 from the user, the timing module 104 starts to measure a duration time period, and the acquiring module 102 acquires the acceleration and the movement direction of the electronic device 1 from the accelerometer 11 and the motion sensor 15 for transmission to the analysis module 103.

The analysis module 103 analyzes the movement direction of the electronic device 1 to axis directions. In the embodiment, as shown in FIGS. 3 and 4, the electronic device 1 is moved along two axis directions X and Y. In another embodiment, the electronic device 1 is moved along three axis directions X, Y, and Z.

When the user has stopped moving the electronic device 1, the timing module 104 stops measuring duration time periods for performing the movement operation. The calculating module 105 calculates a movement vector on each axis direction based on the acceleration and the duration time period using the following equation: S=a*Δt², where, “S” represents a movement vector, “Δt” represents a time change and is equal to the duration time period, and “a” represents the acceleration.

As shown in FIG. 3, the calculating module 105 calculates a movement vector (x2−x1) along the X axis and a movement vector (y2−y1) along the Y axis. As shown in FIG. 4, the calculating module 105 calculates a movement vector (x4−x3) along the X axis and a movement vector (y4−y3) along the Y axis.

The graphic drawing module 106 draws an unlocking graphic based on the movement vectors along the axes and stores the unlocking graphic in the storage unit 13. As shown in FIG. 3, the graphic drawing module 106 draws a square-shaped unlocking graphic. As shown in FIG. 4, the graphic drawing module 106 draws a rectangular-shaped unlocking graphic.

The determination module 107 determines whether or not the unlocking graphic of the electronic device 1 is the same as the preset unlocking graphic in the storage unit 13. If the unlocking graphic is the same as the preset unlocking graphic, the determination module 107 initiates the unlocking module 108. In one embodiment, the determination module 107 determines whether or not the movement vectors of the unlocking graphic are the same as the predetermined movement vectors of the preset unlocking graphic for unlocking the electronic device 1.

The unlocking module 108 unlocks the electronic device 1. In one embodiment, the unlocking module 108 unlocks the electronic device 1 to turn on the display unit 12. In other embodiments, the unlocking module 108 unlocks a locked keypad or keyboard of the electronic device 1.

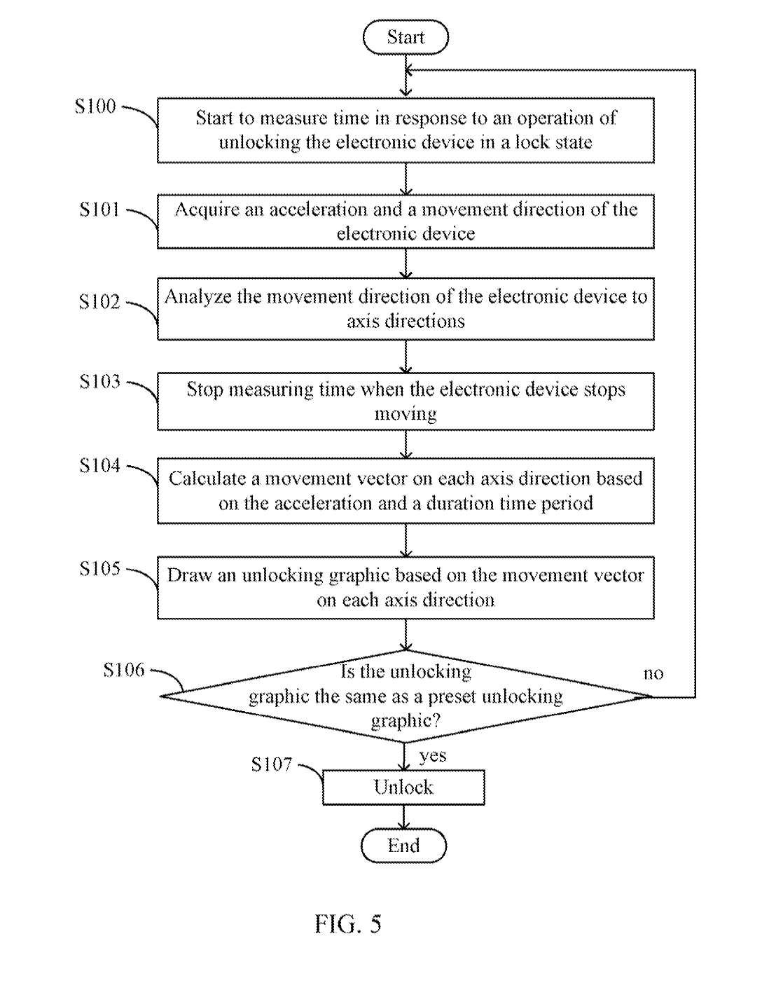

FIG. 5 is a flowchart illustrating one embodiment of a method of unlocking an electronic device 1. Depending on the embodiment, blocks may be added, deleted, or rearranged.

In block S100, the timing module 104 starts to measure time in response to the operation of unlocking the electronic device 1 from the user.

In block S101, the acquiring module 102 acquires the acceleration of the electronic device 1 from the accelerometer 11 and the movement direction from the motion sensor 15.

In block S102, the analysis module 103 analyzes the movement direction of the electronic device 1 to axis directions.

In block S103, when the user stops moving the electronic device 1, the timing module 104 stops measuring duration time periods.

In block S104, the calculating module 105 calculates the movement vector along each axis direction based on the acceleration and the duration time periods from the timing module 104.

In block S105, the graphic drawing module 106 draws an unlocking graphic based on the movement vectors.

In block S106, the determination module 107 determines whether or not the unlocking graphic is the same as the preset unlocking graphic in the storage unit 13. If the unlocking graphic is the same as the preset unlocking graphic, block S107 is implemented. If the unlocking graphic is not the same as the preset unlocking graphic, block S100 is repeated.

In block S107, the unlocking module 108 unlocks the electronic device 1 from the lock state. In one embodiment, the unlocking module 108 unlocks the electronic device 1 from the lock state by turning on the display unit 12 and outputting a message to the display unit 12. In other embodiments, the unlocking module 108 unlocks a locked keypad or keyboard of the electronic device 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An unlocking system for an electronic device, the electronic device comprising an accelerometer to sense an acceleration, a motion sensor to sense a movement direction, a display unit to display information, and storing a preset unlocking graphic for unlocking the electronic device, the unlocking system comprising:
an acquiring module to acquire the acceleration of the electronic device from the accelerometer and the movement direction of the electronic device from the motion sensor in response to an operation of unlocking the electronic device in a lock state;
a timing module to measure a duration time period from a time of receiving the operation to a time that the electronic device stops moving;
an analysis module to analyze the movement direction of the electronic device to axis directions;
a calculating module to calculate a movement vector on each axis direction based on the acceleration and the duration time period;
a graphic drawing module to draw an unlocking graphic based on the movement vector on each axis direction;
a determination module to determine whether or not the unlocking graphic is the same as the preset unlocking graphic; and
an unlocking module to unlock the electronic device from a lock state to an unlock state, when the unlocking graphic is the same as the preset unlocking graphic;
wherein the modules of the unlocking system are executable by at least one processor.

2. The unlocking system of claim 1, further comprising a setup module to set the preset unlocking graphic.

3. The unlocking system of claim 1, wherein the unlocking module is configured to unlock the electronic device from the lock state by unlocking the display unit of the electronic device.

4. The unlocking system of claim 1, wherein the unlocking module is configured to unlock a locked keypad or keyboard of the electronic device.

5. The unlocking system of claim 1, wherein the calculating module is configured to calculate the movement vector on each axis direction based on the formula S=a*Δt², “S” represents a movement vector, “a” represents the acceleration, and “Δt” is the duration time period.

6. The unlocking system of claim 1, wherein the unlocking graphic is a character, a symbol, a two-dimension graphic, or a three-dimension graphic.

7. The unlocking system of claim 1, wherein the analysis module is configured to analyze the movement direction of the electronic device to two axis directions.

8. The unlocking system of claim 1, wherein the analysis module is configured to analyze the movement direction of the electronic device to three axis directions.

9. A method for unlocking an electronic device, the electronic device comprising an accelerometer to sense an acceleration, a motion sensor to sense a movement direction, a display unit to display information, and storing a preset unlocking graphic for unlocking the electronic device, the method comprising:
acquiring the acceleration of the electronic device from the accelerometer and the movement of the electronic device from the motion sensor in response to an operation of unlocking the electronic device in a lock state;
measuring a duration time period from a time of receiving the operation to a time that the electronic device stops moving;
analyzing the movement direction of the electronic device to axis directions;
calculating a movement vector on each axis direction based on the acceleration and the duration time period;
drawing an unlocking graphic based on the movement vector on each axis direction;
determining whether or not the unlocking graphic is the same as the preset unlocking graphic; and
if the unlocking graphic is the same as the preset unlocking graphic, unlocking the electronic device from a lock state to an unlock state.

10. The method of claim 9, further comprising:
setting the preset unlocking graphic.

11. The method of claim 9, further comprising:
unlocking the electronic device from the lock state by unlocking the display unit of the electronic device.

12. The method of claim 9, further comprising:
unlocking a locked keypad or keyboard of the electronic device.

13. The method of claim 9, further comprising:
calculating the movement vector on each axis direction based on the formula S=a*Δt², wherein “S” represents the movement vector, “a” represents the acceleration, and “Δt” is the duration time period.

14. The method of claim 9, wherein the unlocking graphic is a character, a symbol, a two-dimension graphic, or a three-dimension graphic.

15. The method of claim 9, further comprising:
analyzing the movement direction of the electronic device to two axis directions.

16. The method of claim 9, further comprising:
analyzing the movement direction of the electronic device to three axis directions.
